(19) United States
(12) Patent Application Publication
(10) Pub. No.: US 2002/0040384 A1
(43) Pub. Date: Apr. 4, 2002

(54) Communication method using customisable banners

(76) Inventor: John Moetteli, Geneva (CH)

Correspondence Address: John Moetteli, Case Postale 486, Geneva 12, CH-1211, CH

(21) Appl. No.: 09/970,953

(22) Filed: Oct. 4, 2001

Related U.S. Application Data
(60) Provisional application No. 60/238,955, filed on Oct. 4, 2000.

(51) Int. Cl. G06F 15/16

(52) U.S. Cl. 709/201; 709/320

(57) ABSTRACT

A banner management method is provided which operates on a browser user interface on terminals in a network of terminals. The method comprising the steps of: (1) initialising a command file with inputs from a system administrator of the network, including providing an interface by which the system administrator can customize banners displayed on each browser interface, and (2) executing the command file, thus displaying banners as ordered by the command file.

### STATEMENT REGARDING RELATED APPLICATIONS

This patent application claims priority to U.S. provisional patent application No. 60,238,9155, the content of which is incorporated herein by reference.

### BACKGROUND OF THE INVENTION

This invention relates to banner presentation software, in particular to software which allows a user to edit electronic banners and control their display.

Electronic banners have been used for several years on the internet in order to advertise products and/or services via a display in interesting information associated with such products/services. Until now, the control of the content of such browsers has been in the hands of the web sit webmaster. Although he could control the display and timing of display banners on his website, the nature of the message of such banners was necessarily broad, having to appeal to a certain extent to a large number of viewers about whose tastes the webmaster had little or no knowledge.

Users and companies however, have very particular communications needs such as a need for a task reminder or a calendar reminder for upcoming meetings, etc. all very specifically tailored or customized to the user's needs. This information was generally conveyed to the user via specialized software such as Microsoft Outlook or other time management software

Microsoft Office '97 offers an intelligent helper, but control of such helper is completely in the hands of each user. Thus, there is no means by which the management of a company can persistently communicate with its employees in a highly visible manner.

Message boards have been available in different forms. However, the frequency and duration of the showing of messages may not be controlled.

Further unfortunately, most if not all of these programs are closed and therefore not visible during significant intervals of time during the user's working day.

Therefore what is needed is a method which provides customized reminders in a more persistent environment, therefore, increasing the likelihood that the message was communicated.

### BRIEF DESCRIPTION OF THE DRAWINGS

FIG. 1 is a flow chart of the initialization step of the invention.

FIG. 2 is a screen print of a Graphical User Interface on which the invention is implemented.

FIG. 3 is a flow chart of the operational step of the invention.

### SUMMARY OF THE INVENTION

A banner management method is provided which operates on a browser user interface on a terminal's in a network of terminals. The method comprising the steps of (1) initializing a command file with inputs from a system administrator of the network, including providing an interface by which the system administrator can customize banners displayed on each browser interface; and (2) executing the command file, thus displaying banners as ordered by the command file.

### DETAILED DESCRIPTION OF THE PREFERRED EMBODIMENT

This application incorporates by reference the contents of U.S. Pat. No. 5,787,254 and U.S. patent application Ser. No. 09/447,293.

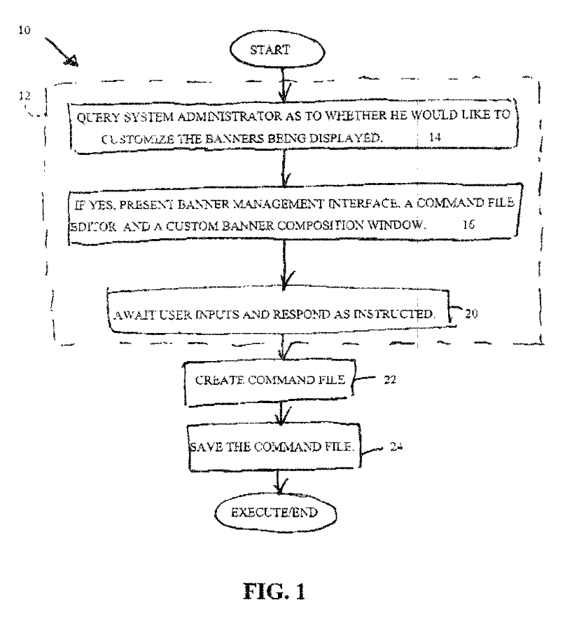

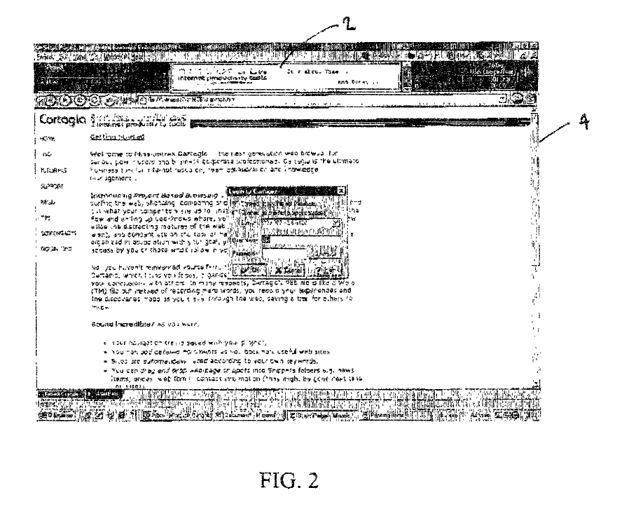

Referring now to FIGS. 1 and 2, the method comprising the steps of (1) initialising a command file with inputs from a system administrator of the network, including providing an interface by which the system administrator can customize banners 2 displayed on each browser interface 4; and (2) executing the command file, thus displaying banners 2 as ordered by the command file.

In the first step, initialization 10, a computer system including at least two personal computers connected in a network, is initialized in an initialization process.

In a first initializing step 12, the method queries a system administrator for initializing inputs including a selection of at least in part customized banners ad any display sequence and time duration information.

In a second initialising step 22, the method creates a command file based on the inputs received.

In a third initialising step 24, the method saves the command file.

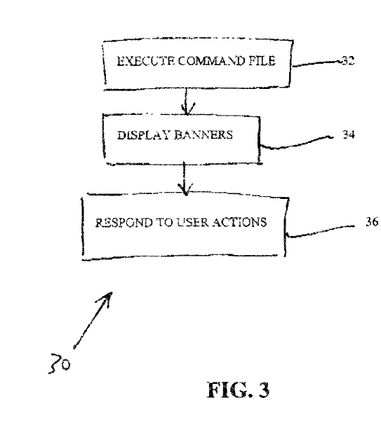

Referring now to FIG. 3, the method 30 of operation of the invention is shown.

In a first operational step 32, upon loading of the browser, the method executes the command file.

In a second operational step 34, the method displays banners according to the command file.

In a third operational step 36, optionally, if someone clicks on the currently displayed banner, the browser performs a prescribed action, such as downloading a document (such as a web page) that is associated with the currently displayed image.

The initialization process 10 will now be described in further detail.

In the first initialization step 12, the following substeps are executed.

In a first substep 13, when the System Administrator logs on to the system admin module, the method presents the user with a popup window which queries the system administrator as to whether he would like to customize the banners being displayed.

In a second substep 16, if the system administrator responds in the alternative via a checkbox on the popup, the method presents the system administrator with a banner management interface presenting a banner directory tree of existing banners organized under themes or subject headings, a command file editor and a customer banner composition window.

In a third substep 20, respond to user inputs to configure the presentation of data and graphics on the banner window.

In the second initialization step 22, the command file editor is used to create the command file.

The banner director tree includes a directory structure of canned and customized banners stored under certain director names, like Productivity, Mission Statement, attitude/morale, PC tips, Research Tips, Meetings, On this Day in History, Dilbert, and birthdays. Selecting a director tree theme opens up subthemes and banners which may be highlighted and copies to the command file using the command file editor.

The command file editors allows the system administrator to select and arrange banners is a presentation order and assign duration times to each banner, thus determining the length of time each banner will be displayed. Optionally, a manner of display can be selected, such as a flashing display, a fade out/in display, a scrolling display, etc.

The custom banner composition window presents the system administrator with an animation graphics and a text editor by which he can input and format the position of text and graphics in creating a custom banner which he can save under the director tree under the folder name of his choosing. The banners created using this editor may be simple text banners such as “All Hands meeting today, 11:30, in the Cafeteria”, or “Jody's birthday—she's 32!”, or “To optimize your PC, periodically delete temp files”

In a third initialization step 24 of the initialisation process 10, after the system administrator has made is selections of banners, including any that he may have created using the custom banner editor, and has ordered the banners to his liking, using the command file editor, he saves the command file.

In the second step of the method of the invention, the system administrator may now click execute, thus executing the command file.

In another feature of the invention the banner management interface queries the system administrator if he would like to create new command files for execution at certain times in the future, such as the next day. The interface of course may provide control means permitting the system administrator to proactively access this calendar feature. Thus, the system administrator may mark for execution in the future the banners of his choosing. Further, the system administrator, using the banner management interface, can create command files which execute only on certain browsers on the company intranet, through association with the browser identifiers of each user. Thus the invention may be used as a reminder system.

It should be noted that the system administrator can be an individual user. In this embodiment each user would be able to customize the banners shown on their browser.

The method is particularly advantageous when used with project-based browsing, in which Internet research is tracked to a particular project name.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use the other features. Accordingly, if is appropriate that the foregoing description be construed broadly and understood as being given by way of illustration and example only, the spirit and scope of the invention being limited only by the appended claims.

What is claimed is:

1. A banner management method encoded on a computer-readable medium operating on a browser user interface on terminals in a network of terminals, the method comprising the steps of (1) initialising a command file with from a system administrator of the network, including providing an interface by which the system administrator can customize banners displayed on each browser interface; and (2) executing the command file, thus displaying banners as ordered by the command file.
